(19) United States
(12) Patent Application Publication
(10) Pub. No.: US 2009/0252584 A1
(43) Pub. Date: Oct. 8, 2009

(54) Tool for Handling of Loads

(75) Inventors: Keijo Kroger, Tampere (FI); Veijo Miihkinen, Tampere (FI); Olavi Savolainen, Tampere (FI)

Correspondence Address: VENABLE LLP, P.O. BOX 34385, WASHINGTON, DC, 20043-9998, US

(73) Assignee: OY MECLIFT LTD., Kangsala (FI)

(21) Appl. No.: 12/085,522

(22) PCT Filed: Nov. 30, 2006
(86) PCT No.: PCT/FI2006/050530

§ 371 Date: May 27, 2008

(30) Foreign Application Priority Data
Dec. 2, 2005 (FI) 20055646

(51) Int. Cl. B66F 9/14

(52) U.S. Cl. 414/667

(57) ABSTRACT

An implement for manipulating and loading containers. A lifting carriage has a total width smaller than a door opening of a container to be loaded. A guide surface extends over the total width of the lifting carriage. Two fork arms are movable and supported by the guide surface. The fork arms have a narrow position for the manipulation of loads, in which a total width of the arms is smaller than the total width of the lifting carriage. Two bearings move the arms. Each bearing is provided between each arm and the guide surface. The fork arms also have a wide position for manipulating containers and for fork pockets of a container, in which the total width of the arms is greater than the total width of the lifting carriage. In another example, two transfer carriages are provided, which are coupled to the lifting carriage and are movable and supported by the guide surface.

### FIELD OF INVENTION

The invention relates to an implement for the handling of loads, and particularly an implement for the manipulation and loading of pallets and freight containers.

### BACKGROUND OF THE INVENTION

According to prior art, various working machines, particularly reach trucks, are used for the unloading and loading of freight containers with various loads, including particularly various units assembled on pallets, platforms or transfer platforms, as well as single paper rolls of various types. An example of a reach truck, whose telescopically operating boom is also equipped with an auxiliary joint, is disclosed in EP 0 410 082 A1. Other examples are given in EP 0 415 608 A2 and U.S. Pat. No. 4,822,237. An example of grapples or forks is disclosed in GB 1 552 533.

Large freight containers are normally loaded so that a working machine with the implements and the tools attached to it is driven at least partly into the freight container. The implement is movably coupled to the working machine, and the tool is typically a fork. With the fork in front, the working machine is driven into the freight container, and the load is placed in its position, after which the working machine is backed up out. The implements and working machines intended for the loading of freight containers are dimensioned so that they fit in the freight container. Particularly the width of the frames of the implements intended for the loading of containers, and especially the width of the forks to be positioned is limited so that they fit in the container with a sufficient clearance, for example to allow for swinging, steering mistakes or changes in the position of the working machine.

Furthermore, working machines are known which are equipped with forks and intended for the manipulation and transportation of containers. The tools of these working machines are not dimensioned to make the stowing of loads into the containers possible.

### SUMMARY OF THE INVENTION

The aim of the present invention is to expand the possibilities for using implements of prior art and simultaneously the working machines utilizing them in such a way that the loading or unloading of a container, as well as the manipulation of the container itself were possible with the same implement, wherein it is particularly an adjustable fork. Said feature also provides additional uses of the implement, particularly if the implement is provided with interchangeable tools, and enhances the operation, since it will not be necessary to use separate working machines for the manipulation of the container itself, or it will not be necessary to interchange the tool with another one, wherein savings are achieved in costs as well as in time.

The total width of the frame of the implement according to the invention is limited so that it can be used for loading a load placed i.e. on pallets, into a container. The implement comprises two forks placed at an adjustable distance and taking a total width that is smaller than the total width of the frame when transfer pallets are manipulated. The forks are arranged to approach each other to such an extent that they are capable of manipulating standardized transfer pallets, at least on the side of their longer flank. On the other hand, the distance between the forks is adjustable so that the forks are capable of transporting a standardized container provided with fork pockets. For the manipulation of the containers, the total width of the forks is greater than the total width of the frame itself. It is characteristic of the invention that the structures supporting the forks, for example various carriages, move at least partly further out to the side edge of the frame, wherein the total width of the frame is effectively utilized.

Said difference in the total width of the frame and the extended forks or carriages makes it possible to stow loads into the container by means of a sufficiently narrow implement. On the other hand, said difference makes it possible to spread out the forks sufficiently for the fork pockets, to allow for the manipulation of the whole container. The transfer movement of the forks or carriages is thus sufficient for versatile uses.

U.S. Pat. No. 4,960,357 discloses a fork of prior art having two fork arms movable in a lifting carriage. The lifting carriage comprises a horizontal bottom girder whose front surface is provided with a guide surface, along which the rolls provided in the arm of the fork rotate. The arm of the fork is pressed against the guide surface by means of said rolls and by the effect of the load. The lifting carriage also comprises a horizontal top girder whose top surface is provided with a guide surface, along which the rolls provided in the arm of the fork rotate. The fork and the load are supported by the guide surface by means of said rolls. The back surface of the top girder is also provided with a guide surface, along which the rolls provided in the arm of the fork rotate. The loads of the fork effective in different directions press the rolls against the guide surfaces. The lower rolls, and normally also the uppermost rolls, are placed on both sides of the arms of the forks, as is also disclosed in WO 91/07345.

In the implementation according to U.S. Pat. No. 4,960,357 or WO 91/07345, the maximum width of the fork spread out is always smaller than the maximum width of the lifting carriage supporting the fork, which limits the use of the tool; thus, for example the fork pockets of the container cannot be utilized. The arms of the fork cannot be spread out wide enough, because otherwise the rolls of the bearings would fall off their guide surfaces. On the other hand, if the total maximum width of the fork arms were increased by widening the frame of the lifting carriage, the tool would not fit in the door opening of the container. Document NL 9200588 discloses an implement for the manipulation of pallets, but in said implement, it is not possible to move the fork arms to very narrow position and to a very wide position by means of an actuator only. The fork arms must also be transferred manually, which slows down the work and is not safe. Furthermore, a slide bearing is utilized in the implement.

The allowable overall dimensions of freight containers are defined, for example, in the standard ISO 668, in which the length for 40, 30, 20, and 10 foot containers is defined as 12,192 mm (40′), 9,125 mm (29′11¼″), 6,058 mm (19′10½″), or 2,991 mm (9′¾″), the width being 2,438 mm (8′) and the height being 2,438 mm (8′) (alternatively 2,591 mm (8′6″) or less than 2,438 mm). A guideline value for the total weight is 30,480 kg, 25,400 kg, 24,000 kg, and 10,160 kg, respectively.

The smallest inner dimensions of the container are 11,998 mm, 8,931 mm, 5,867 mm, or 2,802 mm for the length and 2,330 mm for the width. The smallest dimensions of the door opening of the container are 2,134 mm or 2,261 mm for the height and 2,286 mm for the width. In view of loading the container, the most important dimensions are the width of the door opening, minimum 2,286 mm, and the width of the interior, minimum 2,330 mm.

For the manipulation, the container is often equipped with fork pockets (fork lift pockets) which are provided in pairs at the long flank of the container, in the bottom part of the container. In an example, the fork pockets have a width of 360 mm, their height is 115 mm, and the distance between the centres of the fork pockets is 2,050 mm, wherein the distance between the centres may have a variance of 50 mm. In another example, the fork pockets have a width of 14″ (355.6 mm), their height is 4½″ (114.3 mm), and the distance between the centres is 81″ (2,057.4 mm). The container may also have two pairs of fork pockets, wherein the innermost pair of fork pockets is intended for the manipulation of the empty container. In one example, the fork pockets have a width of 310 mm, their height is 115 mm, and the distance between the centres of the fork pockets is 860 mm.

The implement is also used for the manipulation of pallets which are standardized as well. The external dimensions of a so-called EUR pallet are 1200×800×144 mm. On the longer flank of the pallet, the openings of the pallet for the fork of a forklift have the dimensions of about 378×100 mm, the distance between the centres being about 533 mm, and on the shorter flank of the pallet, the dimensions are about 223×100 mm, the distance between the centres being about 378 mm.

In the invention, we have found that the limitations of prior art can be eliminated by allowing the fork arms to extend partly over the outer edge of the corresponding guide surface or guide surfaces, without disturbing the function of the bearings. In said extreme position, the surface pressure between the fork arms and the guide surface, and the supporting force given by the guide surface is still sufficient for the manipulation of the containers. The corresponding idea also works when the fork arm is carried by a carriage which simultaneously moves along a guide surface in the lifting carriage of the tool and couples the fork with the lifting carriage. A bearing is provided between the transfer carriage and the lifting carriage.

In a particular embodiment of the invention, a slide bearing is provided between the carriage and the guide surface so that the slide bearing does not extend over the outer edge of the transfer carriage or the fork, which is the case, for example, when bearing rolls are used. The bearing is limited, for example, to be narrower than the width of the carriage or the fork, wherein the bearing is placed between the structures. In the invention, for example the slide bearing does not unnecessarily define or limit the total width of the tool or unnecessarily limit the total width of the fork spread out or carriages spread out. By means of the invention, the fork can be extended to be sufficiently wide, for example, for the manipulation of a container. The bearing utilizes the width of the guide surface and the lifting carriage to a maximum extent, when the guide surface extends up to the edge of the lifting carriage.

In the invention, it is possible to move the fork arms to the width corresponding to pallets as well as to the width corresponding to the fork pockets of a freight container solely by means of the actuators of the implement, wherein no manual adjustment of the fork arm will be necessary.

In a particular embodiment of the invention, the slide bearing formed by means of a sliding sheet is also placed eccentrically in relation to the fork arm and the carriage, on the side of the inner edge of the fork arm and the transfer carriage. The length and the total surface area of the slide bearing are sufficient to keep the surface pressure sufficiently low to secure the load-bearing capacity of the implement and to secure the functionality of the bearing. The surface pressure is defined for that section of the slide bearing which is pressed, for example, between the carriage and the guide surface. In the presented embodiment of the invention, the carriage, i.e. the transfer carriage carrying the tool, and the fork arm are separate, to make it possible to remove or change the fork arm without disassembling the structure or removing the transfer carriage from the implement or the lifting carriage.

The extension of the movement of the fork arm and the transfer carriage farther out than the lifting carriage is limited so that the swinging of the fork arm would not affect the functioning. However, the width of the fork arms and the transfer carriage is limited so that the width of the fork can be reduced to be suitable for the manipulation of a pallet.

A significant advantage of the invention is the versatile use of the implement, wherein it is suitable for the loading as well as the manipulation of containers.

### BRIEF DESCRIPTION OF THE DRAWINGS

In the following, the invention will be described in more detail with reference to the appended drawings, in which:

FIG. 1 is a side view of a lifting carriage,

FIG. 2 is a side view of the lifting carriage, a transfer carriage and a fork arm,

FIG. 3 is a rear view of the transfer carriage,

FIG. 4 is a rear view of the lifting carriage, and

FIG. 5 is a rear view of the different positions of the transfer carriages in view of the lifting carriage.

### DETAILED DESCRIPTION OF THE INVENTION

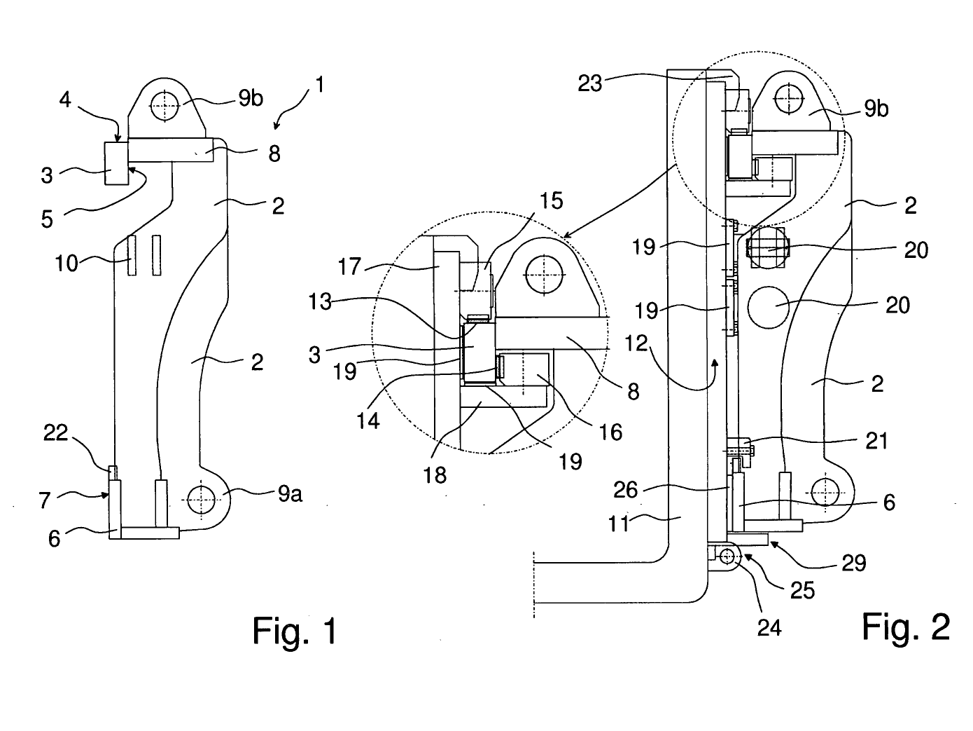

FIG. 1 shows a lifting carriage 1 for an implement in a side view. The lifting carriage 1 consists of a total of four frame parts 2 which are connected by an upper horizontal first boom 3, whose top surface is provided with a first guide surface 4 which is substantially horizontal and faces upwards in this example so that it forms a horizontal surface. FIG. 1 shows a frame part 2 at the end of the lifting carriage 1 and a frame part 2 around the middle of the lifting carriage 1. This frame part 2 is also provided with a lug 9a to which an actuator (not shown in the figure) is to be coupled for controlling the tilting of the implement forward and backward. The actuator is normally a hydraulic cylinder which is also coupled to a boom structure, to which the implement is also connected by means of a joint. The function of the guide surface 4 is to support the structures coupled to the lifting carriage 1 and the loads manipulated by the implement. On the rear surface of the boom 3 there is a second guide surface 5 which is substantially horizontal and in this example faces backwards, wherein it constitutes a vertical surface. The function of the guide surface 5 is to prevent the structures and loads connected to the lifting carriage 1 from falling forward and simultaneously to keep them supported by the guide surface 4. In addition to the perpendicular position, the guide surfaces 4 and 5 may also be placed in a slanted position in relation to each other. The frame parts 2 are also connected by a lower horizontal second boom 6 whose front surface is provided with a third guide surface 7 that is vertical. The function of the guide surface 7 is to support the movable structures loaded by the weight of the load, to the lifting carriage 1. If necessary, the frame parts 2 are also joined by other structures which reinforce the lifting carriage 1, its fittings, or have other functions. For example, the lifting carriage 1 has a horizontal third boom 8, in front of which the boom 3 is attached and which is provided with three lugs 9b that form some of the joints by which the implement is coupled movably to the boom structure of the working machine. The inner surface of the outermost frame part 2 is also provided with a lug 10, to which an actuator 20 for controlling the distance between the fork arms 11 is connected.

FIG. 2 shows both the lifting carriage 1 and a transfer carriage 12 supporting the fork arm 11. The transfer carriage 12 is mounted on the front side of the frame parts 2, and the arm 11, in turn, is suspended on the front side of the transfer carriage 12. The implement comprises a total of two transfer carriages 12 for the two fork arms 11. The arm 11 is L-shaped in a way known as such, and loads are carried on the horizontal teeth, i.e. the arms 12. The arms 11 also fit so deep inside the fork pockets of a container that the vertical part of the arm 11 will be close to the side wall of the container.

The enlargement of FIG. 2 shows the bearing of the implement and particularly the function of a slide bearing in more detail. The frame 17 of the transfer carriage 12 is a vertical boom whose top end, on the side of the lifting carriage 1, is provided with a first bearing housing 15, a first slide bearing 13 being attached to its lower surface. The slide bearing 13 is placed in a recess in the bearing housing 15. The slide bearing 13 is placed against the guide surface 4. The top end of the frame 17, on the side of the lifting carriage 1, is also provided with a second bearing housing 16, a second slide bearing 14 being attached to its front surface. The slide bearing 14 is placed in a recess in the bearing housing 16. The slide bearing 14 is placed against the guide surface 5. The bearing housing 16 is attached to the frame 17 by means of an arm 18 which is placed underneath the boom 3. The frame parts 2 are shaped so that the arm 18 and the bearing housing 16 can pass the frame parts 2 and move along the whole length of the guide surfaces 4 and 5. The front surface of the boom 3, facing the frame 17, and if necessary, also the lower surface facing the arm 18 may be provided with slide bearings 19, but the loading of these points is significantly smaller than the loading of the slide bearings 13 and 14, and they normally have a small clearance.

A third slide bearing 26 is placed in the bottom part of the frame 17, against the guide surface 7, to slide along the guide surface 7. The slide bearing 26 can also be attached to the frame 17 by means of a support or a separate housing forming a part of the frame 17. The slide bearing 26 is horizontal and in this example it faces forward, forming a vertical surface. The orientation may also be slightly oblique.

Also other structures are attached to the frame 17 in view of the functionality of the implement. Each transfer carriage 12 is provided with a lug 19, to which the actuator 20 for moving the transfer carriage 12 is coupled. The actuator 20 is also coupled to the lifting carriage 1. An arresting claw 21 is also, attached to the frame 17 to curl behind a retaining boom 22. The function of the arresting claw 21 is to prevent the frame 17 and simultaneously the transfer carriage 12, the arm 11, and the slide bearing 26 from withdrawing far from the boom 6 and simultaneously from the lifting carriage 1, for example due to swinging. The horizontal retaining boom 22 is fixed on top of the boom 6, on the front side of the frame parts 2. The arresting claw 21 moves between the frame parts 2. On the top end of the arm 11, a suspension claw 23 is provided to be placed on top of the frame 17 to prevent the withdrawal of the arm 11 from the frame 17. In the bottom part of the arm 11, locking means 24 are also provided, by means of which the arm 11 is locked to counterpart means 25 in the bottom part of the frame 17 to prevent the rising of the arresting claw 23 and the arm 11 and the withdrawal of the arm 11 from the frame 17. Thanks to the separateness of the arm 11 and the transfer carriage 12, it is possible to change another fork arm or a totally different tool, for example a grapple for the manipulation of loads, in the transfer carriage 12.

The transfer carriage 12 and the arm 11 can also be coupled to each other in another way, for example with bolts. Furthermore, the transfer carriage 12 and the arm may constitute an integrated, for example welded structure, wherein they are changed together, for replacing the arms 11 movable in the lifting carriage 1, or the fork. The embodiment applying the forks is the most preferable in view of the manipulation of containers, but the presented lifting carriage 1 and transfer carriage 12 can also be utilized in combination with other means, tools and structures for the manipulation of loads. Even then, with the presented transfer carriage 12, it is possible to achieve a large movement range which exceeds the width of the transfer carriage 1 and the guide surfaces. The transfer carriage 12 and the structures related to it may also constitute a uniform or integrated structural unit.

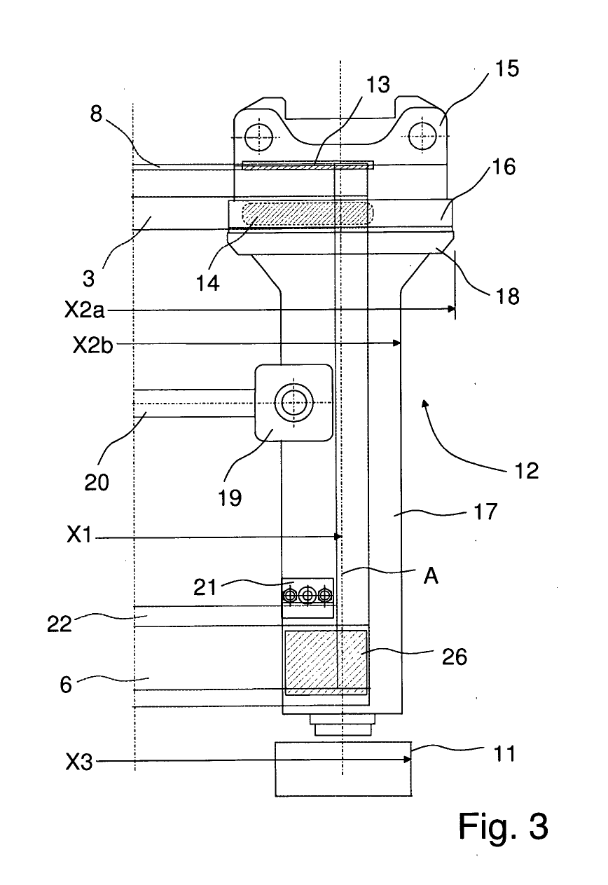

FIG. 3 shows the transfer carriage 12 in a rear view and without the arm 11. The lifting carriage 1 is outlined in FIG. 3 by means of a broken line. The arm 11 is only shown for the horizontal part in the figure. The transfer carriage 12 shown in FIG. 2 is the left-hand-side transfer carriage 12 seen from behind the implement and the lifting carriage 1; FIG. 3 shows the right-hand-side transfer carriage 12 in a corresponding manner, but the transfer carriages 12 are mirror images of each other, particularly in view of the slide bearings 13, 14 and 26.

It can be seen in FIG. 3 that particularly the slide bearing 13 utilizes the guide surface 4 placed against it (FIG. 1) to a maximum extent, when the slide surface 4 extends from one edge of the lifting carriage 1 to the opposite edge. The same principle applies to the slide bearing 14 as well. The slide bearing 13 is even allowed to extend slightly over the edge of the boom 3, as long as the surface pressure of the remaining part is sufficiently low. The surface pressure is caused by the loading and depends on the surface area of the slide bearing. The material and the sliding sheet are known as such, commonly available, and have been selected for the application of the invention.

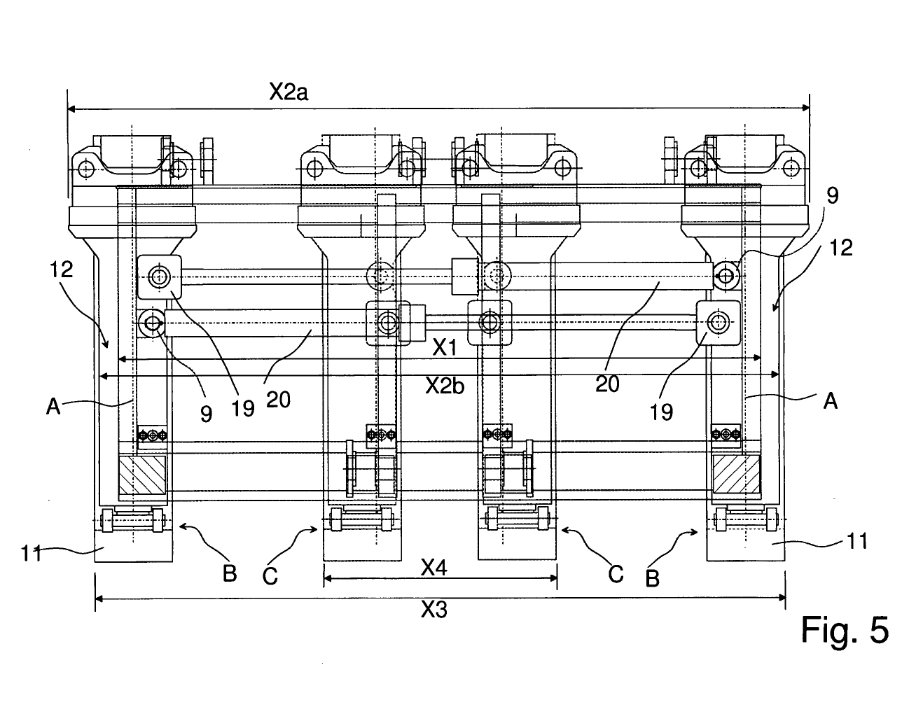

It can be seen in FIG. 3 that the slide bearing 13 as well as the slide bearing 14 are placed eccentrically in relation to the central line A of the transfer carriage 12 which in this case also converges with the central line of the arm 11 (FIG. 2). As a result, it is possible to bring the transfer carriage 12 and the arm 11 farther than the lifting carriage 1 in the lateral direction (to the right in FIG. 3), wherein the arm 11 and/or the transfer carriage 12 will determine the total width X2a of the implement, which is greater than the maximum total width X1 of the lifting carriage 1, thus corresponding particularly to the length of the guide surface 4 and in the presented embodiment also the length of the guide surfaces 5 and 7. The upper part of the frame 17 with its bearings is wider than the rest of the frame 17, but also elsewhere the outer edge of the frame 17 will extend past the lifting carriage 1, resulting in a maximum total width X2b when the fork is in position B (FIG. 5). In this case, the total width X1 is also smaller than the total width X2b. In a corresponding manner, the slide bearing 26 is: also placed eccentrically, wherein the slide bearings 13, 14 and 26 are placed closer to the inner edge of the transfer carriage 12, that is, transferred closer to the second transfer carriage 12 and the central part of the lifting carriage 1. That part of the transfer carriage 12, to which the slide bearing 13 does not extend, can thus be moved farther from the guide surface 4. However, the central line A of the arm 11 and the transfer carriage 12 is placed above the lifting carriage 1, seen from the front, also in the extreme position B of the fork.

Sufficient support of the transfer carriage 12 against unnecessary swinging is secured by means of stopper means 29 fixed to the bottom part of the frame 17 and placed underneath the boom 6 (FIG. 2). The arresting claw 21 is also fixed to the frame 17 eccentrically so that it is placed inside the outermost frame part 2. In the extreme position B of the transfer carriage 12, the arresting claw 21 is placed close to the frame part 2 and it is also used as a stopper if the actuator 21 moving the transfer carriage 12 is broken.

In the example of FIG. 3, also the arm 11 extends wider than the lifting carriage 1 in the lateral direction, wherein the maximum total width X3 of the fork spread out, particularly its arms 11, is greater than the total width X1. The total width X3 is substantial for example in view of the manipulation of the container and its fork pockets. The total width X1, in turn, is essential in view of the narrow door opening of the container, so that loads could be carried into the container. The total width X4 of the narrowed fork (FIG. 5), in turn, is essential in view of the manipulation of single loads to be loaded. The implement is dimensioned so that both the manipulation of the container and the loading of the container with loads would be possible with the same implement.

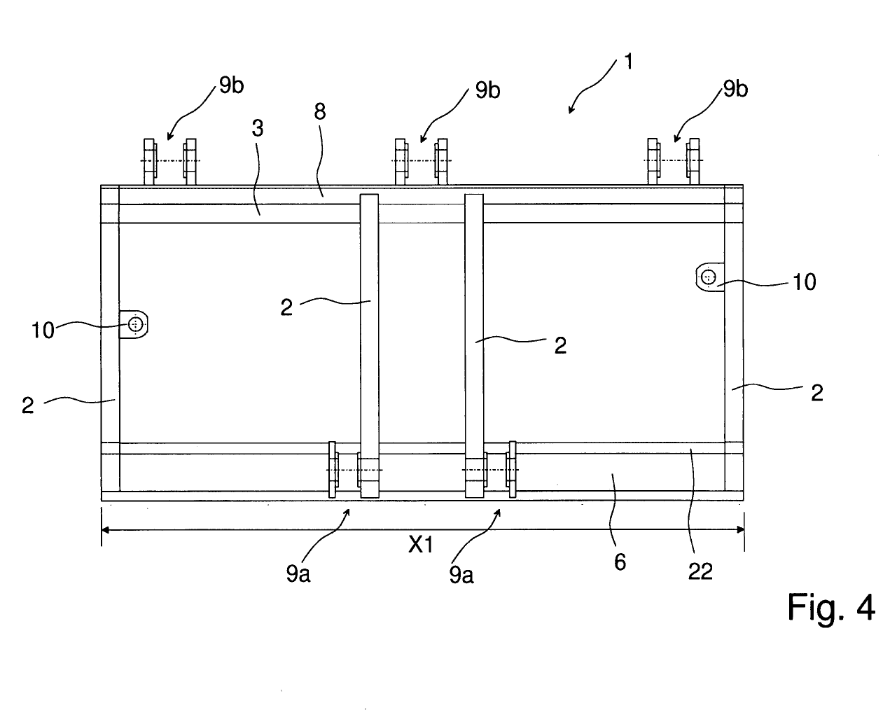

FIG. 4 shows the lifting carriage 1 in a rear view. The frame parts 2 are also provided with lugs 10 for the actuator 20. The function of the actuator 20 (FIG. 5) is to move the transfer carriage 12, and it is connected to the lug 19 of the transfer carriage 12. The actuator 20 is normally a hydraulic cylinder coupled to the control circuit of the working machine, which is also used for controlling the actuators (not shown in the figure) attached to the lugs 9a. It is also possible to attach to the lugs 9a such a structure of the boom which is tilted by the actuators, wherein the actuators are not coupled directly to the lugs 9a. Consequently, the above structure is coupled to the lugs 9a. Three lugs 9b are intended for coupling the implement, i.e. the lifting carriage 1, to the boom of the working machine. The lugs 9b form three coupling points, wherein the structure becomes sufficiently stiff. As shown in FIG. 5, the actuators 20 are placed on top of each other in the horizontal direction and protected between the outermost frame parts 2. The actuators 20 pass the two central frame parts 2.

FIG. 5 also illustrates the different extreme positions of the two transfer carriages 12 and simultaneously the arms 11. In the wide extreme position B of the transfer carriages 12, the total width of the arms 11 is X3. The narrow position C of the transfer carriages 12 in the total width X4 is illustrated by outlining the transfer carriages 12 with a broken line. The actuators 20 move the transfer carriages 12 and simultaneously the arms 11 to the desired position between the total widths X3 and X4 as well. The ratio between the total widths X2a, X2b and X3 of the arms 11 or the transfer carriages 12 and the total width X1 of the lifting carriage 1 should be examined primarily at the bearing 13 but also at the bearing 14 and/or the bearing 26, because at these points, the lifting carriage 1 and the transfer carriage 12 are supported to each other.

With respect to the dimensions, the total width X1 of the lifting carriage 1 is about 2,150 to 2,050 mm, preferably 2,100 mm; the distance between the centres Z of the fork arms 11 in the wide position B is about 1,950 to 2,050 mm, preferably 2,000 mm, and in the narrow position about 460 to 560 mm, preferably 510 mm. It should be mentioned that the transfer carriage 12 extends about 49 to 69 mm, preferably 59 mm farther out in relation to the lifting carriage 1. In a corresponding manner, the arm 11 extends about 64 to 84 mm, preferably 74 mm father out in relation to the lifting carriage 1. The width of the arm 11 is preferably 250 mm, and the width of the bottom part of the transfer carriage is about 220 mm.

The invention is not limited solely to the examples discussed or presented above, but it may vary according to the appended claims.

1. An implement for the manipulation of loads, comprising:
a lifting carriage having a total width,
a first guide surface which is substantially horizontal and extends over the total width of the lifting carriage,
two fork arms which are coupled to the lifting carriage and which are movable in the lifting carriage, supported by the first guide surface,
two actuators coupled to the lifting carriage, wherein the actuators are configured to move the fork arms to at least a narrow position to manipulate pallets, in which a total width of the fork arms is smaller than the total width of the lifting carriage, and wherein the actuators move the fork arms to at least a wide position to manipulate freight containers, in which the total width of the fork arms is greater than the total width of the lifting carriage, and
two bearings for moving the fork arms, wherein each bearing is provided between each fork arm and the first guide surface.

2. The implement according to claim 1, wherein:
the total width of the lifting carriage is smaller than a door opening of a standard freight container to be loaded,
the total width of the fork arms in said narrow position corresponds to a standard pallet, and
the total width of the fork arms in said wide position corresponds to the fork pockets of a standard freight container.

3. The implement according to claim 1, wherein the total width of the lifting carriage 1 is about 2,150 to 2,050 mm; the distance between the centre lines of the fork arms in the wide position is about 1,950 to 2,050 mm, and in the narrow position about 460 to 560 mm.

4. The implement according to claim 1, further comprising:
two transfer carriages configured to couple each fork arm to the lifting carriage, wherein each bearing is placed between each lifting carriage and the first guide surface, and wherein in the wide position the transfer carriages have a total width greater than the total width of the lifting carriage.

5. The implement according to claim 4, wherein the width of the transfer carriage is about 205 to 235 mm, and the extension of the transfer carriage over said guide surface in the wide position of the forks is about 54 to 64 mm.

6. The implement according to claim 4, wherein the bearing comprising a sliding sheet placed asymmetrically in relation to the transfer carriage and/or the fork arm.

7. The implement according to claim 1, wherein the bearing comprises a sliding sheet placed asymmetrically in relation to the fork arm.

8. The implement according to claim 1, wherein the total width of the fork arms in the wide position is greater than the total width of the lifting carriage, and the distance between the central lines of the fork arms is smaller than the total width of the lifting carriage.

9. The implement according to claim 1, wherein the actuator comprises a hydraulic cylinder.

10. The implement according to claim 1, wherein the lifting carriage comprises three lugs attached to the lifting carriage configured to suspend the lifting carriage to the boom of the working machine so that the lifting carriage can rotate in relation to a horizontal rotation axis.

11. The implement according to claim 1, wherein the lifting carriage further comprises a substantially horizontal second guide surface, against which the fork arms are pressed, and a second bearing between the second guide surface and the fork arms.

12. The implement according to claim 11, wherein the second bearing comprises a sliding sheet placed asymmetrically in relation to the fork arm.

13. The implement according to claim 1, further comprising
a substantially horizontal third guide surface, against which the fork arms are pressed, and
a third bearing between the third guide surface and the fork arms.

14. The implement according to claim 13, wherein the third bearing comprises a sliding sheet placed asymmetrically in relation to the fork arm.

15. The implement according to claim 1, wherein each fork arm further comprises an arresting claw movable at the lifting carriage, to prevent the withdrawal of the fork arms away from the lifting carriage.

16. The implement according to claim 10, wherein the working machine comprises a reach truck.

17. The implement according to claim 1, wherein the container comprises a standard freight container.

18. An implement for the manipulation of loads, comprising:
a lifting carriage having a total width,
a first guide surface which is substantially horizontal and extends over the total width of the lifting carriage,
two transfer carriages which are coupled to the lifting carriage and are movable in the lifting carriage, supported by the first guide surface,
two actuators coupled to the lifting carriage, wherein the actuators move the fork arms to at least a narrow position to manipulate pallets, in which a total width of the transfer carriages is smaller than the total width of the lifting carriage, and wherein the actuators are move the fork arms to at least a wide position to manipulate freight containers, in which the total width of the transfer carriages is greater than the total width of the lifting carriage, and
two bearings for moving the transfer carriages, wherein each bearing is provided between each transfer carriage and the first guide surface.

19. The implement according to claim 18, wherein:
the total width of the lifting carriage is smaller than a door opening of a standard freight container to be loaded,
the total width of the transfer carriages in said narrow position corresponds to a standard pallet, and
the total width of the transfer carriages in said wide position corresponds to the fork pockets of a standard freight container.

20. The implement according to claim 18, wherein the total width of the lifting carriage 1 is about 2,150 to 2,050 mm; the distance between the centre lines of the fork arms in the wide position is about 1,950 to 2,050 mm, and in the narrow position about 460 to 560 mm.

21. The implement according to claim 18, wherein the bearing comprises a sliding sheet placed asymmetrically in relation to the transfer carriage.

22. The implement according to claim 18, wherein the total width of the transfer carriages in the wide position is greater than the total width of the lifting carriage, and the distance between the central lines of the transfer carriages is smaller than the total width of the lifting carriage.

23. The implement according to claim 18, wherein the lifting carriage further comprises a substantially horizontal second guide surface, against which the transfer carriages are pressed, and a second bearing between the second guide surface and each transfer carriage.

24. The implement according to claim 23, wherein the second bearing is a sliding sheet placed asymmetrically in relation to the transfer carriage.

25. The implement according to claim 18, wherein the lifting carriage further comprises a substantially horizontal third guide surface, against which the transfer carriages are pressed, and a third bearing between the third guide surface and each transfer carriage.

26. The implement according to claim 25, wherein the third bearing comprises a sliding sheet placed asymmetrically in relation to the transfer carriage.

27. The implement according to claim 18, wherein each transfer carriage comprises fixing and a lock, to which a replaceable tool can be coupled.

28. An implement for the manipulation of loads, comprising:
a lifting carriage with a total width,
a first guide surface which is substantially horizontal and extends over the total width of the lifting carriage,
two transfer carriages which are coupled to the lifting carriage and are movable in the lifting carriage, supported by the first guide surface,
two actuators coupled to the lifting carriage, wherein the actuators move the fork arms to at least a narrow position, in which a total width of the transfer carriages is smaller than the total width of the lifting carriage, and wherein the actuators move the fork arms to at least a wide position, in which the total width of the transfer carriages is greater than the total width of the lifting carriage, and
two bearings for moving the transfer carriages, wherein each bearing comprises a sliding sheet fixed to the transfer carriage, placed between the transfer carriage and the first guide surface, and wherein said sliding sheet is placed eccentrically in relation to the transfer carriage and transferred towards the central part of the lifting carriage.

29. The implement according to claim 28, wherein the lifting carriage further comprises a substantially horizontal third guide surface, against which the transfer carriages are pressed, and a bearing between the third guide surface and each transfer carriage, wherein said bearing comprises a sliding sheet fixed to the transfer carriage and placed eccentrically in relation to the transfer carriage and transferred towards the central part of the lifting carriage.

30. The implement according to claim 28, wherein the lifting carriage further comprises a substantially horizontal second guide surface, against which the transfer carriages are pressed, and a bearing between the second guide surface and each transfer carriage, wherein said bearing comprises a sliding sheet placed eccentrically in relation to the transfer carriage and transferred towards the central part of the lifting carriage.

31. The implement according to claim 28, wherein the narrow position is for the manipulation of pallets and the wide position is for the manipulation of freight containers.
